(19) United States
(12) Patent Application Publication
(10) Pub. No.: US 2004/0131271 A1
(43) Pub. Date: Jul. 8, 2004

(54) Image compression method using wavelet transform

(76) Inventors: Kyeongsoon Cho, Sungnam-si (KR); Seonyoung Lee, Seoul (KR)

Correspondence Address: CANTOR COLBURN LLP, 55 Griffin Road South, Bloomfield, CT, 06002, US

(21) Appl. No.: 10/393,082

(22) Filed: Mar. 20, 2003

(30) Foreign Application Priority Data
Jan. 7, 2003 (KR) 10-2003-0000753

(51) Int. Cl. G06K 9/36; G06K 9/46

(52) U.S. Cl. 382/240

(57) ABSTRACT

An image compression method using a wavelet transform is provided. The image compression method includes a first wavelet transform process, a storage process, a second wavelet transform process, a quantization process and an entropy encoding process. The first wavelet transform process wavelet-transforms image data as many as a reference wavelet transform number of times in any one direction of a row-direction or a column-direction, to thereby output first low-frequency wavelet transform data and first high-frequency wavelet transform data. The second wavelet transform process wavelet-transforms the first low-frequency wavelet transform data and the last first high-frequency wavelet transform data which are stored in a memory as many as the reference wavelet transform number of times in a direction differing from that performed in the first wavelet transform process, to thereby output second low-frequency wavelet transform data and second high-frequency wavelet transform data. Accordingly, since an amount of calculation for a wavelet operation during wavelet transforming becomes less, the wavelet transform can be performed in a short time, a size of a wavelet transform circuit can be made compact, a quantity of data to be stored in the memory can be diminished, and an exchange of data with a memory can be reduced, to thereby lessen a power consumption.

### BACKGROUND OF THE INVENTION

1. Field of the Invention

The present invention relates to an image compression method, and more particularly, to an image compression method for compressing image data using an improved wavelet transform.

2. Description of the Related Art

To compress digital image data is for the purpose of reducing a bit rate of an image input for transmission, or heightening an efficiency of a storage device for image data.

There are a block DCT (Discrete Cosine Transform) coding method and a WT (Wavelet Transform) coding method as an image compression method.

FIG. 1 is a block diagram showing a general image compression apparatus using a wavelet transform.

The image compression apparatus using a wavelet transform of FIG. 1 includes a wavelet transformer 1 which receives digital image data (ID) and wavelet-transforming the received digital image data (ID), a memory 2 which stores the wavelet transform result from the wavelet transformer 1 or outputs the stored wavelet transform result to the wavelet transformer 1, a quantizer 3 which quantizes the wavelet-transformed data and outputs the quantization data, and an entropy encoder 4 which outputs compressed data (CD) by compressing quantization data by means of a Huffman coding or arithmetic coding method.

FIG. 2 is a flow chart view for illustrating an image compression method using a conventional wavelet transform.

The image compression method using a conventional wavelet transform includes: a row-direction wavelet transform process S1 for wavelet-transforming received image data in a row-direction of the received image data and outputting row-direction high-frequency wavelet transform data H1 of a high-frequency band and row-direction low-frequency wavelet transform data L1 of a low-frequency band; a first storage process S2 for storing the row-direction wavelet transform data H1 of the high-frequency band and the row-direction wavelet transform data L1 of the low-frequency band, which are output from the row-direction wavelet transform process S1, in a memory; a column-direction wavelet transform process S3 for receiving the row-direction high-frequency wavelet transform data H1 of the high-frequency band and the row-direction low-frequency wavelet transform data L1 of the low-frequency band which is output from the first storage process S2, wavelet-transforming the received image data in a column-direction of the received image data, and outputting a first wavelet image data HHn representing a diagonal edge component of a high-frequency band, a second wavelet image data LHn representing a horizontal signal edge component of a high-frequency band, a third wavelet image data HLn representing a vertical signal edge component of a high-frequency band, and a fourth wavelet image data LLn representing a low-frequency band without having an edge component; a second storage process S4 for storing the fourth wavelet image data LLn which is output from the column-direction wavelet transform process S3, in a memory; a step comparison process S5 for comparing a wavelet transform number of times of the image data in the row-direction and in the column-direction, with a reference wavelet transform number of times determined by a user, and performing the row-direction wavelet transform step and the column-direction wavelet transform step with respect to the fourth wavelet image data LLn stored in the second storage process S4 until both the wavelet transform numbers of times equal; a quantization process S6 for outputting quantization data with respect to the first wavelet image data HHn, the second wavelet image data LHn, the third wavelet image data HLn, and the fourth wavelet image data LLn if the wavelet transform number of times of the image data in the row-direction and in the column-direction equals the reference wavelet transform number of times; and an entropy encoding process S7 for receiving the quantization data output from the quantization process S6 and outputting compressed data by compressing quantization coefficient data by means of a Huffman coding or arithmetic coding method.

The operation of the image compression method using the conventional wavelet transform follows.

If the reference wavelet transform number of times is three (3), the row-direction wavelet transform process S1 performs a row-direction wavelet transform of image data input as shown in FIG. 3A, and divides the image data into the row-direction high-frequency wavelet transform data H1 of a high-frequency band and the row-direction low-frequency wavelet transform data L1 of a low-frequency band and outputs the divided result as shown in FIG. 3B. In order to perform a column-direction wavelet transform process S3, the row-direction high-frequency wavelet transform data H1 of the high-frequency band and the row-direction low-frequency wavelet transform data L1 of the low-frequency band are stored in a memory S2, and the row-direction high-frequency wavelet transform data H1 of the high-frequency band and the row-direction low-frequency wavelet transform data L1 of the low-frequency band are read again from the memory, to then perform a wavelet transform of the image data in the column-direction, and divide the input image data into first wavelet image data HH1, second wavelet image data LH1, third wavelet image data HL1 and fourth wavelet image data LL1 of a first step where n equals one (1) as shown in FIG. 3C. Since the reference wavelet transform number of times is three (3) in the step comparison process S5, the fourth wavelet image data LL1 of the first step is stored in the memory in the second storage process S4 and then the fourth wavelet image data LL1 is read again from the memory, to thereby perform the row-direction wavelet transform process S1, the first storage process S2, the column-direction wavelet transform process S3 and the second storage process S4 and divide the fourth wavelet image data into first wavelet image data HH2, second wavelet image data LH2, third wavelet image data HL2 and fourth wavelet image data LL2 of a second step where n equals two (2) as shown in FIG. 3D. Then, according to the above processes again, the row-direction wavelet transform process S1, the first storage process S2, the column-direction wavelet transform process S3 and the second storage process S4 are performed for the fourth wavelet image data LL2 of the second step and the fourth wavelet image data LL2 is divided into first wavelet image data HH3, second wavelet image data LH3, third wavelet image data HL3 and fourth wavelet image data LL3 of a third step where n equals three (3) as shown in FIG. 3D. In the quantization process S6, the quantization data is output for every wavelet image data HH3, LH3, HL3 and LL3 which is divided through the first through third steps (from n=1 to n=3). In the entropy encoding process S7, the quantization data is received and then compressed by the Huffman coding or arithmetic coding method, to output compressed data.

As described above, in the case of the conventional image compression method, the input image data should be sequentially wavelet-transformed necessarily in the row-direction and the column-direction in order to perform a wavelet transform of a one-step, and then all of the previously performed high-frequency band and low-frequency band row-direction wavelet transform data is stored in a memory in order to perform a column-direction wavelet transform. Also, since the stored row-direction wavelet transform data should be read and then the column-direction wavelet transform should be performed with the row-direction high-frequency band and low frequency band wavelet transform data, an amount of calculation necessary for the wavelet operation becomes large during performing the column-direction wavelet transform and thus much time is consumed for the wavelet transform. Also, since all of the previously performed high-frequency band and low-frequency band row-direction wavelet transform data is stored in a memory, a quantity of data to be stored in a memory becomes large.

Also, in the case of the conventional image compression method, the wavelet transform of the image data should be performed in the row-direction and in the column-direction alternately. For this purpose, the wavelet transform data should be stored in a memory and read out therefrom whenever the wavelet transform is performed alternately in the row and column-directions. As a result, since a frequent exchange of data is performed with respect to a memory, a power consumption is considerably large. Particularly, as a wavelet transform number of times is larger, a data exchange number of times with respect to the memory becomes larger.

### SUMMARY OF THE INVENTION

To solve the above problems, it is an object of the present invention to provide an image compression method using a wavelet transform capable of reducing a power consumption by storing only the first low-frequency wavelet transform data, and the last first high-frequency wavelet transform data among plural pieces of the wavelet transform data after performing a wavelet transform in one direction of a row-direction or a column-direction as many as a reference wavelet transform number of times, in a memory, and performing a wavelet transform of the wavelet transform data stored in the memory in the other direction as many as the reference wavelet transform number of times, in which a small amount of calculation necessary for a wavelet operation during a wavelet transform enables a quick wavelet transform to be performed, a size of a circuit for a wavelet transform can be made small, a quantity of data to be stored in a memory can be made small, and a data exchange number of times with respect to a memory can be reduced.

To accomplish the above object of the present invention, there is provided an image compression method using a wavelet transform, the image compression method comprising: a first wavelet transform process which wavelet-transforms image data as many as a reference wavelet transform number of times determined by a user in either one direction of a row-direction or a column-direction, to thereby output a single piece of first low-frequency wavelet transform data of a low-frequency band and at least one piece of first high-frequency wavelet transform data of a high-frequency band; a storage process which stores the first low-frequency wavelet transform data, and the last high-frequency wavelet transform data output among the first high-frequency wavelet transform data output from the first wavelet transform process, during a wavelet transform, in a memory; a second wavelet transform process which wavelet-transforms the first low-frequency wavelet transform data and the last first high-frequency wavelet transform data which are stored in a memory as many as the reference wavelet transform number of times in a direction differing from that performed in the first wavelet transform process, to thereby output a single piece of second low-frequency wavelet transform data of a low-frequency band and a plural pieces of second high-frequency wavelet transform data of a high-frequency band; a quantization process which outputs quantization data for the first high-frequency wavelet transform data excepting the last first high-frequency wavelet transform data in the first wavelet transform process and the second low-frequency wavelet transform data and the second high-frequency wavelet transform data both of which are output from the second wavelet transform process; and an entropy encoding process which receives the quantization data output from the quantization process and then outputs compressed data by a Huffinan coding or arithmetic coding method.

Accordingly, since an amount of calculation for a wavelet operation during wavelet transforming becomes less, the wavelet transform can be performed in a short time, a size of a wavelet transform circuit can be made compact, a quantity of data to be stored in the memory can be diminished, and an exchange of data with a memory can be reduced, to thereby lessen a power consumption.

### BRIEF DESCRIPTION OF THE DRAWINGS

The above object and other advantages of the present invention will become more apparent by describing the preferred embodiment thereof in more detail with reference to the accompanying drawings in which:

FIG. 1 is a block diagram showing a general image compression apparatus;

FIG. 2 is a flow chart view for illustrating an image compression method using a conventional wavelet transform;

FIGS. 3A through 3D show a transform status representing a status of an image divided by a conventional wavelet transform, respectively;

FIG. 4 is a flow chart view for illustrating an image compression method using a wavelet transform according to the present invention; and

FIGS. 5A through 5F show a transform status representing a status of an image divided by a wavelet transform, respectively, according to the present invention.

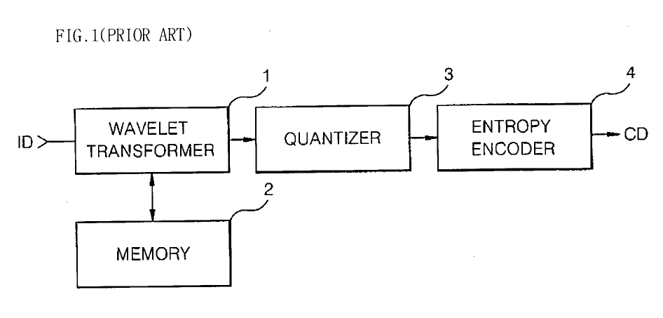

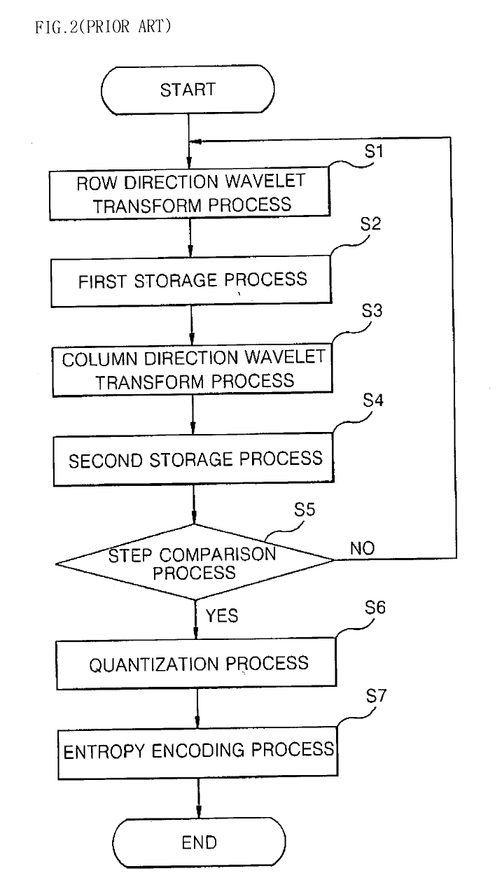

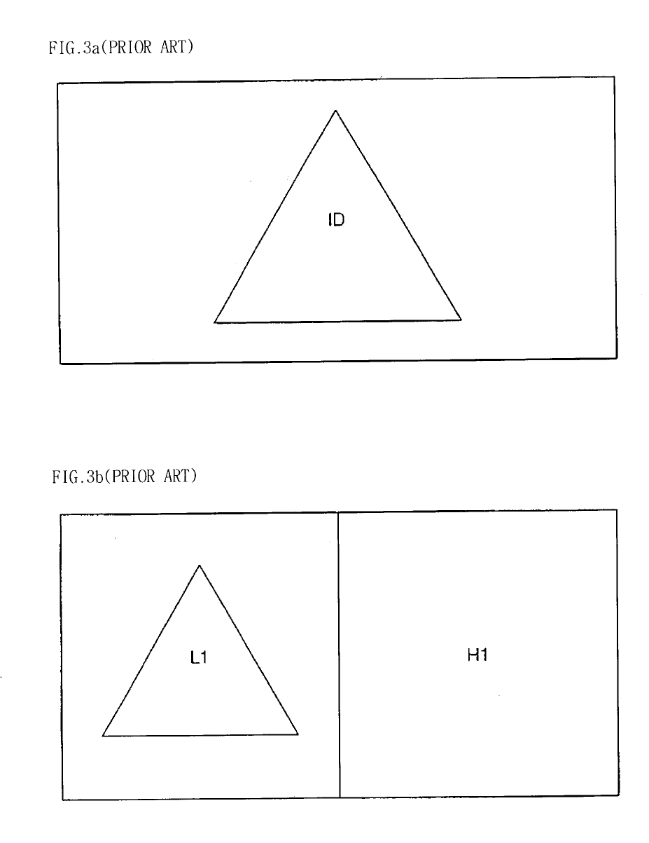

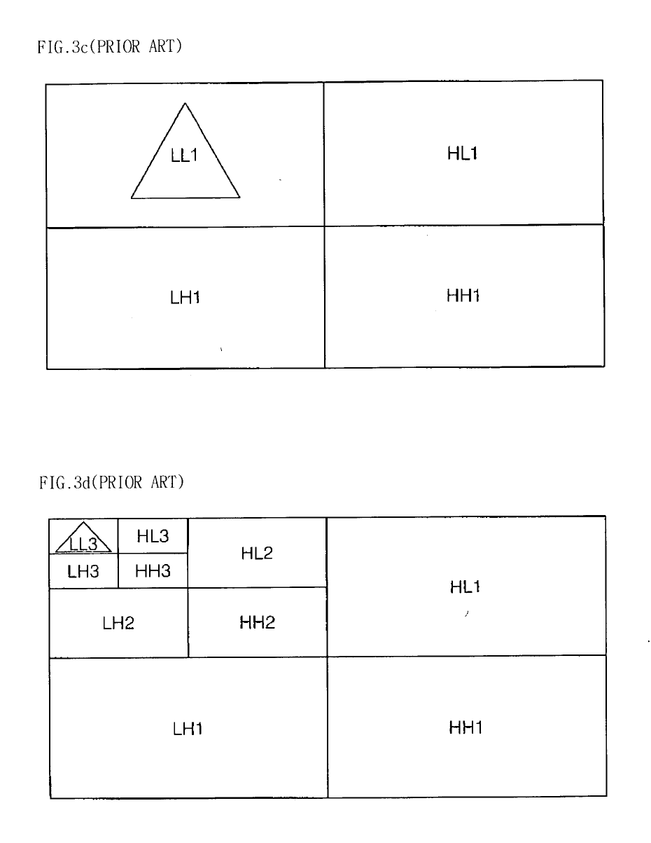

### DETAILED DESCRIPTION OF THE INVENTION

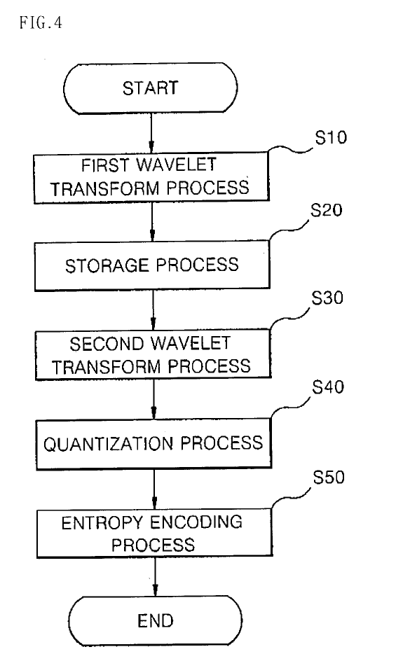

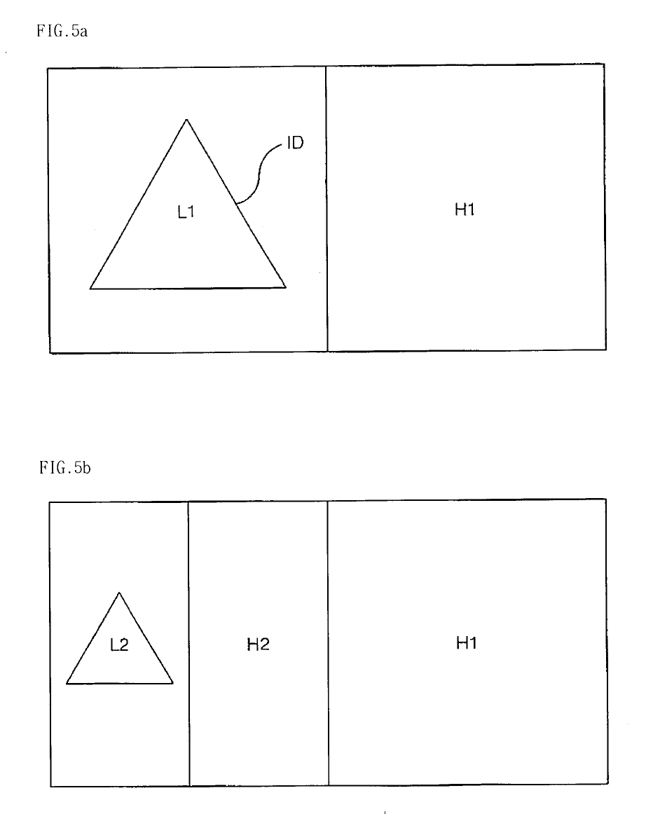

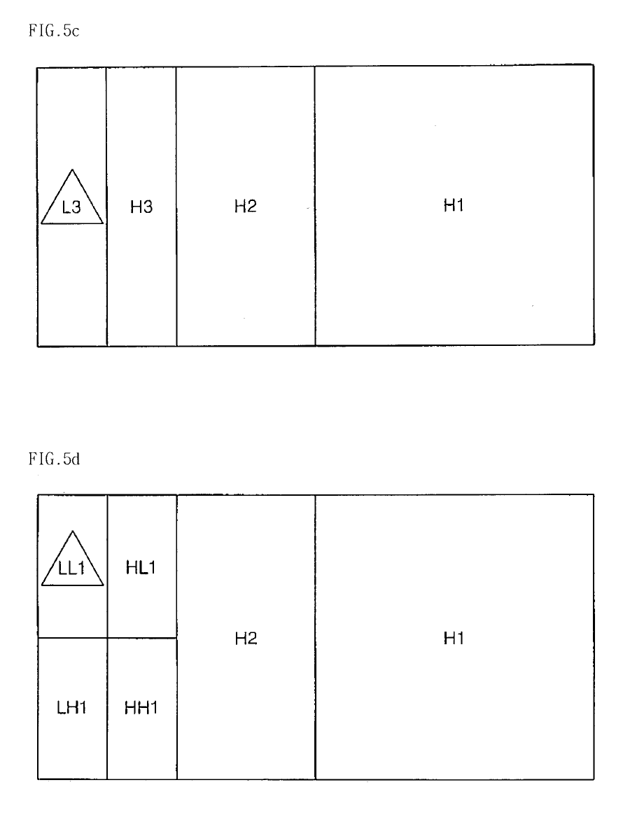

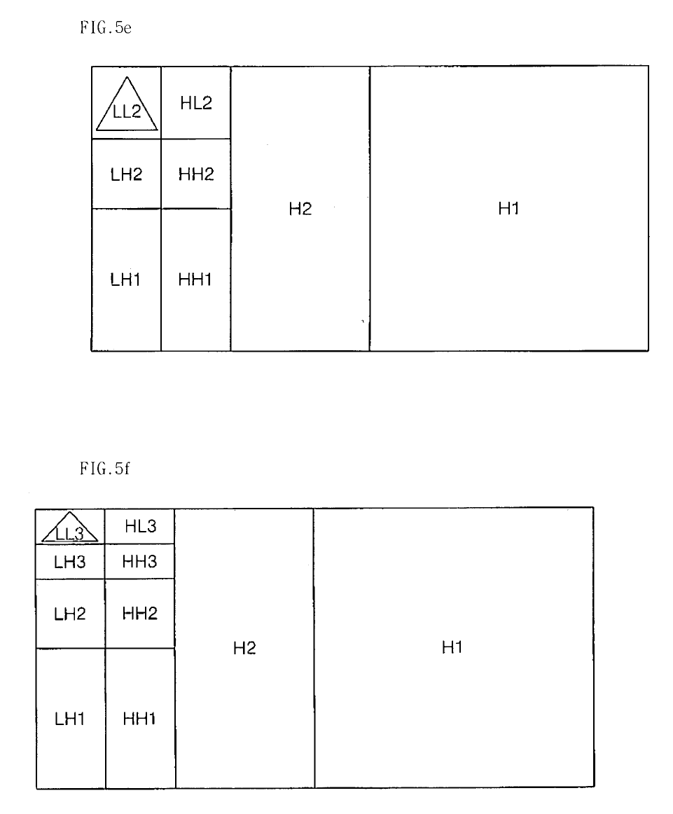

An image compression method using a wavelet transform according to the present invention will be described below in detail with reference to FIGS. 4 through 5F.

As shown in FIG. 4, an image compression method according to the present invention includes a first wavelet transform process S10, a storage process S20, a second wavelet transform process S30, a quantization process S40 and an entropy encoding process S50.

The first wavelet transform process S10 wavelet-transforms image data as many as a reference wavelet transform number of times determined by a user in either one direction of a row-direction or a column-direction of image data (ID), to thereby output a single piece of first low-frequency wavelet transform data L3 of a low-frequency band and at least one piece of first high-frequency wavelet transform data H1, H2, and H3 of a high-frequency band.

The storage process S20 stores the first low-frequency wavelet transform data L3, and the last high-frequency wavelet transform data H3 among the first high-frequency wavelet transform data H1, H2, and H3, which are output from the first wavelet transform process S10, in a memory.

The second wavelet transform process S30 wavelet-transforms the first low-frequency wavelet transform data L3 and the last first high-frequency wavelet transform data H3 which are stored in a memory as many as the reference wavelet transform number of times in a direction differing from that performed in the first wavelet transform process S10, to thereby output a single piece of second low-frequency wavelet transform data LL3 of a low-frequency band and a plural pieces of second high-frequency wavelet transform data HH1, LH1, HH2, LH2, HH3, LH3, and HL3 of a high-frequency band.

The quantization process S40 outputs quantization data for the first high-frequency wavelet transform data H1 and H2 excepting the last first high-frequency wavelet transform data H3 in the first wavelet transform process SIO and the second low-frequency wavelet transform data LL3 and the second high-frequency wavelet transform data HH1, LH1, HH2, LH2, HH3, LH3, and HL3 both of which are output from the second wavelet transform process S30.

The entropy encoding process S50 receives the quantization data output from the quantization process S40 and then outputs compressed data by a Huffman coding or arithmetic coding method.

The operation of the image compression method using a wavelet transform according to the present invention follows.

FIGS. 5A through 5F show a transform status representing a status of an image divided by a wavelet transform, respectively, according to the present invention, in case that a reference wavelet transform number of times is three (3).

The first wavelet transform process S10 wavelet-transforms image data (ID) shown in FIG. 5A in a row-direction three times as many as a reference wavelet transform number of times determined by a user, and divides the image data into first wavelet transform data L3 of a low-frequency band and three pieces of first high-frequency wavelet transform data H1, H2, and H3 of a high-frequency band, to then output the divided result. That is, if the image is wavelet-transformed in a row-direction as shown in FIG. 5A, it is divided into first low-frequency wavelet transform data L1 of a low-frequency band and first high-frequency wavelet transform data H1 of a high-frequency band. If the first low-frequency wavelet transform data L1 is also wavelet-transformed in a row-direction, it is divided into second low-frequency wavelet transform data L2 of a low-frequency band and second high-frequency wavelet transform data H2 of a high-frequency band, as shown in FIG. 5B. If the second low-frequency wavelet transform data L2 is wavelet-transformed in a row-direction, it is divided into third low-frequency wavelet transform data L3 of a low-frequency band and third high-frequency wavelet transform data H3 of a high-frequency band, as shown in FIG. 5C. Since a reference wavelet transform number of times is three (3), the row-direction wavelet transform of the image data is terminated.

The storage process S20 stores the third low-frequency wavelet transform data L3, and the third high-frequency wavelet transform data H3 among the high-frequency wavelet transform data H1, H2, and H3, which are output from the first wavelet transform process S10, in a memory.

The second wavelet transform process S30 wavelet-transforms the first low-frequency wavelet transform data L3 and the last first high-frequency wavelet transform data H3 which are stored in a memory in the storage process S20 as many as the reference wavelet transform number of times, in a column-direction differing from that performed in the first wavelet transform process S10, to thereby output a single piece of second low-frequency wavelet transform data LL3 of a low-frequency band and a plural pieces of second high-frequency wavelet transform data HH1, LH1, HH2, LH2, HH3, LH3, and HL3 of a high-frequency band.

That is, the third low-frequency wavelet transform data L3 and the row-direction last third high-frequency wavelet transform data H3 which is output during the last wavelet transform are wavelet-transformed in a column-direction as shown in FIG. 5D, to then be divided into a first wavelet image data HH1 representing a diagonal edge component of a high-frequency band, a second wavelet image data LH1 representing a horizontal signal edge component of a high-frequency band, a third wavelet image data HL1 representing a vertical signal edge component of a high-frequency band, and a fourth wavelet image data LL1 representing a low-frequency band without having an edge component. Then, as shown in FIG. 5E, the third wavelet image data HL1 and the fourth wavelet image data LL1 are wavelet-transformed in a column-direction, to then be divided into a fifth wavelet image data HH2 representing a diagonal edge component of a high-frequency band, a sixth wavelet image data LH2 representing a horizontal signal edge component of a high-frequency band, a seventh wavelet image data HL2 representing a vertical signal edge component of a high-frequency band, and an eighth wavelet image data LL2 representing a low-frequency band without having an edge component. Then, if the seventh wavelet image data HL2 and the eighth wavelet image data LL2 are wavelet-transformed in a column-direction, they are divided into a ninth wavelet image data HH3 representing a diagonal edge component of a high-frequency band, a tenth wavelet image data LH3 representing a horizontal signal edge component of a high-frequency band, an eleventh wavelet image data HL3 representing a vertical signal edge component of a high-frequency band, and a twelfth wavelet image data LL3 representing a low-frequency band without having an edge component, as shown in FIG. 5F. Since a reference wavelet transform number of times is three (3), the column-direction wavelet transform of the image data is terminated.

As described above, the above embodiment has been described with respect to the case that image data is wavelet-transformed in a row-direction and then in a column-direction. However, even if image data is wavelet-transformed in a column-direction and then in a row-direction, the same result as that of the other case is obtained.

A high-frequency band does not influence much upon a compression rate or a picture quality in comparison with a low-frequency band. Accordingly, even if image data is wavelet-transformed in a row-direction continuously, and then only the row-direction wavelet-transformed low-frequency band L3 and high-frequency band H3 are wavelet-transformed in a column-direction, an image compression result odes not vary greatly.

The quantization process S40 outputs quantization data for the first and second high-frequency wavelet transform data H1 and H2 output from the first wavelet transform process S10, and the first wavelet image data HH1, the second wavelet image data LH1, the fifth wavelet image data HH2, the sixth wavelet image data LH2, the ninth wavelet image data HH3, the tenth wavelet image data LH3, and the eleventh wavelet image data HL3, all of which belong to the high-frequency band and the twelfth wavelet image data LL3 of the low-frequency band without having an edge component, all of which are output from the second wavelet transform process S30.

The entropy encoding process S50 receives the quantization data output from the quantization process S40 and then outputs compressed data by a Huffman coding or arithmetic coding method.

As described above, the present invention provides an image compression method using a wavelet transform capable of reducing a power consumption by storing only the first low-frequency wavelet transform data, and the last first high-frequency wavelet transform data among plural pieces of the wavelet transform data after performing a wavelet transform in one direction of a row-direction or a column-direction as many as a reference wavelet transform number of times, in a memory, and performing a wavelet transform of the wavelet transform data stored in the memory in the other direction as many as the reference wavelet transform number of times, in which a small amount of calculation necessary for a wavelet operation during a wavelet transform enables a quick wavelet transform to be performed, a size of a circuit for a wavelet transform can be made small, a quantity of data to be stored in a memory can be made small, and a data exchange number of times with respect to a memory can be reduced.

The present invention is not limited in the above-described embodiment. It is apparent to one who is skilled in the art that there are many variations and modifications without departing off the spirit of the present invention and the scope of the appended claims.

What is claimed is:

1. An image compression method using a wavelet transform, the image compression method comprising:
a first wavelet transform process which wavelet-transforms image data as many as a reference wavelet transform number of times determined by a user in either one direction of a row-direction or a column-direction, to thereby output a single piece of first low-frequency wavelet transform data of a low-frequency band and at least one piece of first high-frequency wavelet transform data of a high-frequency band;
a storage process which stores the first low-frequency wavelet transform data, and the last high-frequency wavelet transform data output among the first high-frequency wavelet transform data output from the first wavelet transform process, during a wavelet transform, in a memory;
a second wavelet transform process which wavelet-transforms the first low-frequency wavelet transform data and the last first high-frequency wavelet transform data which are stored in a memory as many as the reference wavelet transform number of times in a direction differing from that performed in the first wavelet transform process, to thereby output a single piece of second low-frequency wavelet transform data of a low-frequency band and a plural pieces of second high-frequency wavelet transform data of a high-frequency band;
a quantization process which outputs quantization data for the first high-frequency wavelet transform data excepting the last first high-frequency wavelet transform data in the first wavelet transform process and the second low-frequency wavelet transform data and the second high-frequency wavelet transform data both of which are output from the second wavelet transform process; and
an entropy encoding process which receives the quantization data output from the quantization process and then outputs compressed data by a Huffman coding or arithmetic coding method.

2. The image compression method of claim 1, wherein the reference wavelet transform number of times is two or three.
